(19) United States
(12) Patent Application Publication
(10) Pub. No.: US 2012/0006165 A1
(43) Pub. Date: Jan. 12, 2012

(54) Food Slicers

(75) Inventor: Andrew Thornton, Hascombe (GB)

(73) Assignee: DKB Household UK Limited

(21) Appl. No.: 13/042,754

(22) Filed: Mar. 8, 2011

(30) Foreign Application Priority Data
Jul. 7, 2010 (GB) 1011479.1

(51) Int. Cl. B26D 7/22

(52) U.S. Cl. 83/397

(57) ABSTRACT

A foodstuff slicer includes a support frame carrying a support with a support surface and a slicing blade including a cutting edge situated above the support surface, whereby a foodstuff article may be slid along the support surface into contact with the cutting edge to cut a slice from it. A guard member including at least one guard limb is guided to move transversely to the support surface between an operative position, in which it extends in front of and adjacent to the cutting edge and prevents access to the cutting edge, and an inoperative position, in which it permits access to the cutting edge. A release member is guided to move parallel to the support surface and includes at least one release limb. One of the guard limb and the release limb includes a ramp formation and the other of the guard limb and the release limb includes a follower cooperating with the ramp formation, whereby movement of the release member results in movement of the guard member between the operative and inoperative positions.

### FIELD OF THE INVENTION

The present invention relates to a food slicer and is particularly concerned with that type of such slicer which is commonly referred to as a mandolin. Such slicers comprise a support frame, a support affording a support surface for supporting the food to be sliced and a slicing blade with a cutting edge spaced above the support surface. Such slicers are used in particular for slicing fruit and vegetables and, in use, the food article is slid manually linearly along the support surface into contact with the blade to cut a slice from the food article. This process is repeated as often as desired to produce the desired number of slices. The thickness of the slices is determined by the distance perpendicular to the support surface between the cutting edge and the support surface.

In order that the slicer is readily usable without having to apply on excessive manual force, it is necessary and usual for the cutting edge to be extremely sharp. However, a sharp cutting edge projecting up above the support surface constitutes an obvious safety hazard and there is clearly a risk of inadvertent injury.

### DESCRIPTION OF PRIOR ART

A mandolin is available on the market which seeks to overcome this problem. Instead of the support being stationary with respect to the support frame, as is usual, the support is mounted so as to be movable. It is supported at its end remote from the slicing blade on slideways on the two sides of the support frame and at its end closest to the slicing blade it carries one or more ramp surfaces which rest on a transverse bar forming part of the support frame. Provided at the end of the support frame furthest from the slicing blade is a release member which is coupled to the support and is movable away from the slicing blade against the force of a restoring spring. The support is normally in an inoperative position in which it extends slightly above the cutting edge of the blade and thus shields it and prevents inadvertent harmful contact with it. However, if it is wished to use the mandolin, the release member is moved manually away from the blade and this results in movement of the food support in the same direction also. As the food support moves, its end furthest from the blade slides along and is supported by the slideways. The or each ramp surface also moves with respect to the support bar and the shape of the ramp surface(s) results in the end of the food support also moving downwardly. When the release member is fully actuated, the food support reaches an operative position, the end of the food support closest to the blade is spaced from the blade horizontally and situated at a lower level than the blade. The blade is therefore now spaced above the food support surface and a food article may be slid along the food support surface into contact with the blade in order to slice it.

Whilst this known mandolin is effective as regards minimising the risk of injury to the user, it suffers from a number of disadvantages. The fact that the food support is movable and supported at one end only on two spaced slideways inherently results in it being relatively fragile and flimsy and inadequately supported and it is therefore subject to damage and breakage. When the food support is in its operative position, it is supported at its end closest to the blade only by engagement of the inclined ramp surfaces on the support bar and the application of significant downward pressure on the food support, which is common when slicing e.g. relatively firm vegetables, tends to result in relative movement of the ramp surfaces and the bar and thus in variable thickness of the slices which are produced.

It is therefore the object of the invention to provide a vegetable slicer of manual type in which the cutting edge is reliably shielded at all times other than when the slicer is in use, thereby reliably preventing inadvertent injury but in which the problems referred to above are at least largely eliminated.

### SUMMARY OF THE INVENTION

According to the present invention there is provided a foodstuff slicer including a support frame carrying a support, which affords a support surface, and a slicing blade including a cutting edge situated above the support surface, whereby a foodstuff article may be slid along the support surface into contact with the cutting edge to cut a slice from it, a guard member which includes a guard limb and is guided to move transversely to the support surface between an operative position, in which it extends in front of and adjacent to the cutting edge and prevents access to the cutting edge, and an inoperative position, in which it permits access to the cutting edge, and a release member which is guided to move substantially parallel to the support surface and includes a release limb, one of the guard limb and the release limb including a ramp formation and the other of the guard limb and the release limb including a follower cooperating with the ramp formation, whereby movement of the release member results in movement of the guard member between the operative and inoperative positions.

Thus in the slicer in accordance with the invention, the support function and the guarding function are provided by different components and not by one and the same component as in the known mandolin referred to above. This enables the support surface to be supported very much more positively and to be effectively rigidly connected to the support frame and this allows the risk of deflection of the support surface and thus of variability in the thickness of the slices of foodstuff to be eliminated. The guard member includes a portion which is movable upwardly from an inoperative position, in which it does not obscure the cutting edge of the blade and the blade may therefore be used for slicing food, into an operative position in which it extends immediately in front of the cutting blade and thus prevents inadvertent access to it and thus inadvertent injury to the user in a simple and reliable manner.

The guard member and the release member may each include only one limb but this would result in the actuating force acting on the guard member only at a single position. Whilst this may be acceptable under certain circumstances, it is preferable for the actuating force to be applied at two separate positions and it is therefore preferred that the release member is of generally U shape and includes a handle to which manual pressure may be applied to move it and two release limbs and the guard member includes a guard which is movable into and out of a position, in which it prevents access to the cutting edge, and two guard limbs, each of which extends adjacent a respective release limb, each associated pair of guard and release limbs affording a respective ramp formation and follower. In this construction, movement of the release member will be translated into movement of both of the guard limbs in a direction transverse, and preferably perpendicular, to the support surface and this will result in more reliable and positive movement of the guard member into and out of the operative position.

The or each ramp formation and associated follower may take a number of forms but in one preferred embodiment one of the or each guard limb and the or each release limb affords one or more slots inclined to the support surface, which constitute ramp formations, and the other of the or each guard limb and the or each release limb carries one or more followers in the form of a projection received in a respective slot. As a practical matter, it makes little difference if the slot or slots are formed in the release limbs or the guard limbs.

The or each release limb may be guided to move substantially parallel to the support surface in a number of ways but in the preferred embodiment the or each release limb is accommodated within a respective elongate channel defined by the support frame which constrains it to move linearly substantially parallel to the support surface. Similarly, the or each guard limb may be guided to move transversely, and preferably perpendicularly, to the support surface in a number of ways but it is preferred that the or each guard limb is also accommodated within a respective one of the channels adjacent a respective release limb and that the or each guard limb carries at least one guide formation which cooperates with a respective guide formation on the support frame to guide the guard limb to move transverse to the support surface.

It is preferred that the slicer includes one or more biasing means, preferably in the form of springs, acting on the release member and the support frame and urging the release member towards the position in which the guard member is in the operative position. This means that as soon as no manual force is applied to the release member, it will immediately be moved by the spring or springs such that the guard member is moved to a position in which access to the cutting blade is prevented. It is preferred that the release member includes a latch operable to lock it in a position in which the guard member is in an operative position so as automatically to eliminate the risk of inadvertent actuation of the release member and thus inadvertent, undesired exposure of the cutting edge of the blade.

It may of course be desirable to vary the thickness of the foodstuff slices which are produced by the slicer and this can be readily achieved by providing a number of food supports of different thickness and by ensuring that the food support is removable and may thus be replaced by a food support of a different thickness. It is, however, preferred that the food support includes a mechanism by which it may be selectively moved in a direction perpendicular to the support surface so as to vary the spacing of the support surface from the cutting edge in a direction perpendicular to the support surface.

The cutting blade may be of any desired shape and may thus, for instance, constitute a linear blade which extends across the width of the support frame. In this event, the guard member will of course include a linear guard portion, whose size corresponds to that of the blade and may be moved into and out of a position in which it extends across the front of the cutting edge and thus prevents access to it. However, in an alternative embodiment, the slicing blade includes two portions inclined to one another in a V shape and the guard member therefore includes a guard portion which is of corresponding V shape. In this case, the food support is in practice likely also to include a portion which is of correspondingly V shape so that the foodstuff article to be sliced will be supported on the support surface during the slicing process.

Further features and details of the invention will be apparent from the following description of one specific embodiment which will be given by way of example with reference to the accompanying drawings.

### BRIEF DESCRIPTION OF THE DRAWINGS

FIG. 1 is a perspective view of a food slicer or mandolin in accordance with the invention;

FIG. 2 is an underneath view of the mandolin with the side covers removed;

FIG. 3 is a perspective view of the release member and the guard member in the inoperative position;

FIG. 4 is a side view of the release member and the guard member in the inoperative position; and

FIG. 5 is a side view of the release member and the guard member in the operative position.

### DESCRIPTION OF THE PREFERRED EMBODIMENT

The mandolin includes a generally rectangular support frame 2 which affords a flat upper surface 4 and in which a pentangular opening 6 is formed. The opening 6 is defined by two sides which are parallel to one another, a third side which connects and is perpendicular to them and fourth and fifth sides, which are inclined to one another at an actuate angle. Secured to the fourth and fifth sides is a V-shaped slicing blade 8, which extends parallel to the support surface and whose free edge is a cutting edge. Although the blade is V-shaped in this case, it will be appreciated that it could have a different shape and, in particular, that it could be a straight blade which extends across the width of the support frame. Located within at least the triangular portion of the recess 6 is a food support 10, which affords an upper support surface which is spaced by a small distance below the cutting edge. The food support 10 may be removable and replaceable by a similar food support of different thickness so as to permit the vertical spacing between the support surface and the cutting edge and thus the thickness of the slices that are produced to be varied. However, in the present case the food support 10 is connected to the support frame 2 by a mechanism which permits its height to be varied as desired by rotation of a knob 12. The details of this mechanism forms no part of the present invention and will therefore not be described in detail.

Situated above the food support 10 is a food holder comprising a movable carriage 12 and a retaining cap 14. The carriage 12 comprises a flat plate in which there is a hole surrounded by an upstanding peripheral wall (not shown). The retaining cap is in the nature of an inverted cup and fits over the peripheral wall. The carriage 12 has two depending side flanges 16, each of which carries an inwardly projecting bead or ledge (not shown), which engages beneath a respective flange or ledge 18 on each side surface of the support frame 2. The carriage 12 is thus held captive on the support frame and is able to be slid back and forth along its length.

In use, the retaining cap 14 is removed and a food article, such as a vegetable or piece of fruit, is placed within the tubular wall upstanding from the carriage and it is thus in contact with the food support 10. The cap 14 is then replaced and the carriage is slid back and forth along the support frame 2. Each time the food article contracts the blade 10, a slice is cut from it, the thickness of which is determined by the vertical spacing between the cutting edge of the blade and the support surface.

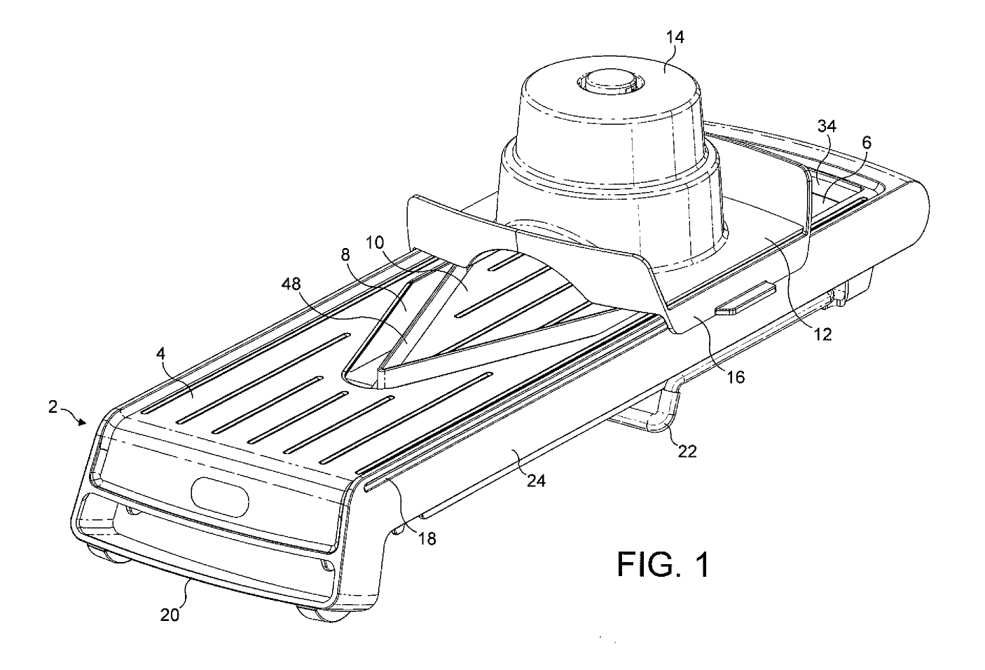

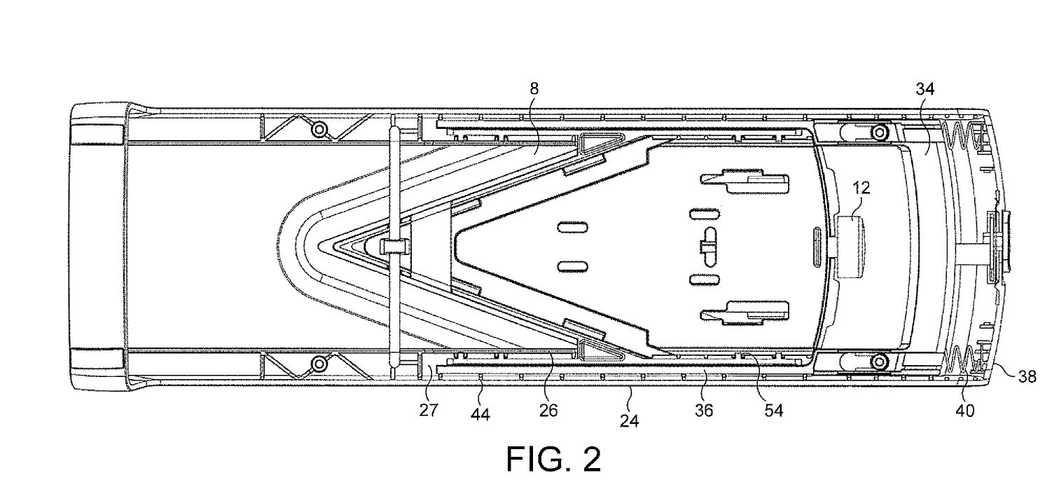

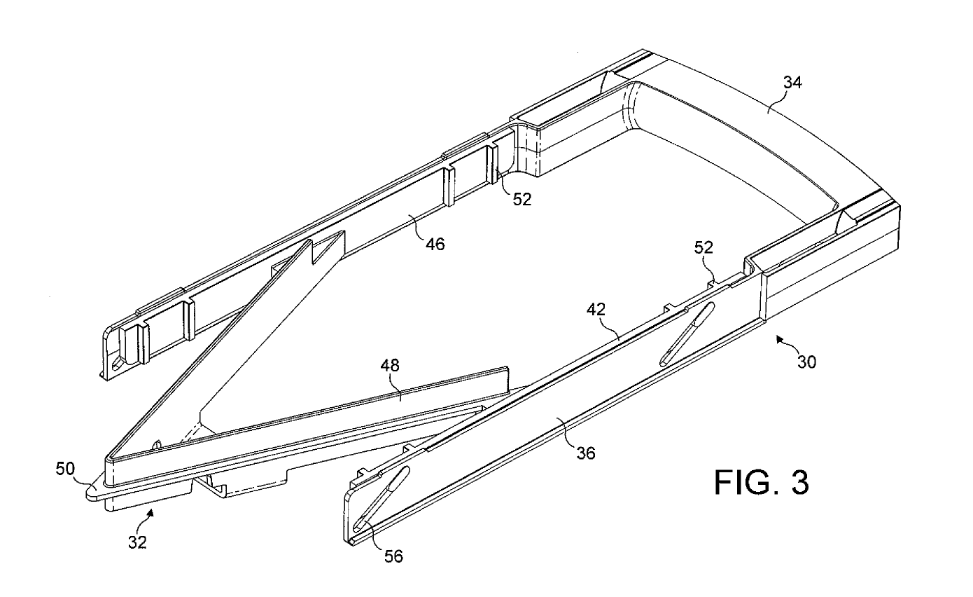

As best seen in FIGS. 1 and 2, the support frame 2, which is of generally rectangular shape and in this case is a one-piece plastic moulding, has an integral support leg 20 at its end closest to the apex of the pentangular opening 6. Pivotally connected to its underside at the other end is a rather longer support leg 22. When the support leg 22 is pivoted downwardly to its operative position, the mandolin will be supported on the two support legs in an inclined orientation due to the fact that the leg 22 is longer than the leg 20. The two side surfaces of the support frame 2 are constituted by depending side plates 24 integral with the upper surface 4. Also integral with the upper surface 4 are two depending flanges 26 which are parallel to and extend closely adjacent a respective side plate 24. Each side plate 24, together with its associated flange 26, defines a respective channel 27. The underside of these channels is normally closed by a respective cover plate but these cover plates have been omitted from FIG. 2 for the sake of clarity.

Located on the underside of the support frame 2 is an assembly comprising a release member 30 and a guard member 32. The release member comprises a handle 34 and two parallel limbs 36. The handle 34 extends across the width of the opening 6 in the support frame adjacent the rear wall 38 of the frame. The handle 34 carries a sliding latch member 35 which may selectively lock the handle 34 in its operative position. Situated between the handle 34 and the rear wall 38 are two compression springs 40, which urge the handle 34, and thus also the limbs 36, to the left, as seen in FIG. 2. The two limbs 36 are slidably accommodated within a respective channel 27. The upper surface of each limb 36 is immediately adjacent the underside of the plate affording the surface 4 of the support frame. A lateral flange 42 integral with the lower edge of each limb 36 is immediately the lower end surface of a plurality of shallow ribs 44 integral with the inner surface of the associated side wall 24 of the support frame 2. Each limb 36 is therefore guided to move linearly within its associated channel in a direction which is substantially parallel to the surface 4. The guard member includes two parallel spaced limbs 46, each of which is in surface contact with the internal surface of a respective limb 36 of the release member 30. The two free ends of a V-shaped guard 48 are integral with the inner surface of the two limbs 46. The size and shape of the two arms of the guard 48 correspond to the size and shape of the V-shaped slicing blade 8. Integral with the outer surface of the two arms of the guard 48 is an abutment ledge 50. Integral with the internal surface of each limb 46 of the guard member 30 is a plurality of spaced vertically extending ribs 52, each of which is slidably retained in a correspondingly shaped vertical groove defined by a respective pair of spaced ribs 54 formed on the outer surface of the associated flange 26. The guard member 32 is thus constrained to be movable only in a direction perpendicular to the support surface 10. Formed in each limb 36 of the release member are two spaced inclined slots 56, the lower surface of each of which constitutes a ramp surface. Integral with the outer surface of each limb 46 of the guard member are two spaced projections or followers 58, each of which is received in a respective slot 56.

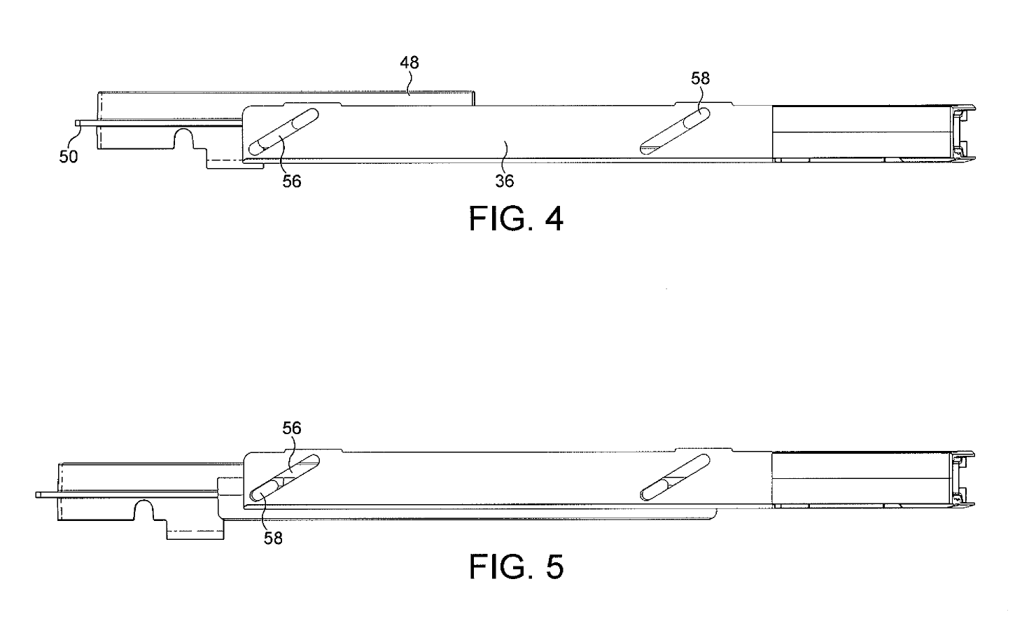

The guard 48 has two different positions with respect to the support frame and the slicing blade. In its normal or operative position, it projects upwardly through the narrow gap between the cutting edge of the blade 8 and the support surface in close proximity to the cutting edge. In this position the projections 58 occupy their uppermost position in the slots 56, as shown in FIG. 4. This is the position seen in FIG. 1 in which it shields or obscures the cutting edge of the blade and thus prevents access to it by the fingers of a user or the like. The cutting blade therefore does not constitute a safety hazard and there is no risk of inadvertent injury. If, however, it is desired to use the mandolin, the user applies a force to the handle 34 and moves it rearwardly, that is to say away from the blade 8, against the biasing force of the springs 40. This movement produces linear sliding movement in the same direction of the limbs 36 of the release member 30 within the channels in which they are accommodated. As the limbs 36 and thus also the slots 56 move to the right, as seen in FIG. 4, the followers 58 necessarily move along the slots 56, that is to say along the ramp surfaces, because the limbs 48 of the guard member are unable to move in the direction in which the limbs 36 move. This movement of the followers 58 in the slots 56 necessarily results in movement of the guard member vertically downwardly as seen in FIG. 4, that is to say perpendicular to the plane of the support surface, as a result of the guiding action of the ribs 52. The guard thus moves downwardly to expose the cutting edge of the blade. The relative positions of the guard member and the release member in this inoperative position are shown in FIG. 5. The mandolin may then be used in the conventional manner to slice a foodstuff article and pressure must be maintained on the handle continuously whilst doing so. When the slicing procedure is at an end, the pressure on the handle is released and the handle then moves to the right as seen in FIGS. 2 and 4, under the action of the springs 40. The process described above is then reversed and the guard member is moved upwardly back to the position shown in FIG. 4 in which it again obscures the cutting edge of the blade.

1. A foodstuff slicer including a support frame carrying a support, which affords a support surface, and a slicing blade including a cutting edge situated above the support surface, whereby a foodstuff article may be slid along the support surface into contact with the cutting edge to cut a slice from it, a guard member which includes a guard limb and is guided to move transversely to the support surface between an operative position, in which it extends in front of and adjacent to the cutting edge and prevents access to the cutting edge, and an inoperative position, in which it permits access to the cutting edge, and a release member which is guided to move substantially parallel to the support surface and includes a release limb, one of the guard limb and the release limb including a ramp formation and the other of the guard limb and the release limb including a follower cooperating with the ramp formation, whereby movement of the release member results in movement of the guard member between the operative and inoperative positions.

2. A slicer as claimed in claim 1 in which the release member is of generally U shape and includes a handle to which manual pressure may be applied to move it and two release limbs and the guard member includes a guard, which is movable into and out of a position in which it prevents access to the cutting edge, and two guard limbs, each of which extends adjacent a respective release limb, each associated pair of guard and release limbs affording a respective ramp formation and follower.

3. A slicer as claimed in claim 1 in which one of the or each guard limb and the or each release limb affords one or more slots inclined to the support surface, which constitute ramp formations, and the other of the or each guard limb and the or each release limb carries one or more followers in the form of a projection received in a respective slot.

4. A slicer as claimed in claim 1 in which the or each release limb is accommodated within a respective elongate channel defined by the support frame which constrains the release limb to move linearly substantially parallel to the support surface.

5. A slicer as claimed in claim 4 in which the or each channel also contains a respective guard limb which carries at least one guide formation which cooperates with a respective guide formation on the support frame, the cooperating guide formations guiding the guard limb to move transverse to the support surface.

6. A slicer as claimed in claim 1 including one or more springs acting on the release member and the support frame and urging the release member towards a position in which the guard member is in the operative position.

7. A slicer as claimed in claim 6 including a latch operable to lock the release member in a position in which the guard member is in an operative position.

8. A slicer as claimed in claim 1 in which the support includes a mechanism by which it may be selectively moved in a direction perpendicular to the support surface so as to vary the spacing of the support surface from the cutting edge in a direction perpendicular to the support surface.

9. A slicer as claimed in claim 1 in which the slicing blade includes two portions inclined to one another in a V shape and the guard member includes a portion which is of corresponding V shape.
